(19) United States
(12) Patent Application Publication
(10) Pub. No.: US 2010/0314365 A1
(43) Pub. Date: Dec. 16, 2010

(54) Method and Apparatus for Using a Laser to Both Score and Emblazon a Wrapping Sheet

(76) Inventors: Jeffrey D. Frey, JR., Dover, DE (US); Douglas M. Lehmann, Park Ridge, NJ (US); Paul E. Doll, Madison, WI (US)

Correspondence Address: FITCH EVEN TABIN & FLANNERY, 120 SOUTH LASALLE STREET, SUITE 1600, CHICAGO, IL, 60603-3406, US

(21) Appl. No.: 12/483,325

(22) Filed: Jun. 12, 2009

(51) Int. Cl. B23K 26/38; B65B 11/00

(52) U.S. Cl. 219/121.69; 53/462; 219/121.68

(57) ABSTRACT

A laser is used to both score and emblazon a sheet to thereby provide a scored, emblazoned sheet. That scored, emblazoned sheet is then used to wrap an item (such as, but not limited to, a foodstuff item). By one approach this can comprise providing a plurality of lasers and exposing a substantially taut sheet to this plurality of lasers. So configured, these lasers are used substantially contemporaneously with one another such that each laser both scores and emblazons a corresponding portion of the substantially taut sheet to provide the aforementioned scored, emblazoned sheet.

### RELATED APPLICATION

This application is related to co-pending and co-owned U.S. patent application Ser. No. 11/969,680, entitled Method and Apparatus for Laser Scored Packaging and which is incorporated by reference in its entirety herein.

### TECHNICAL FIELD

This invention relates generally to wrapping sheets and more particularly to the use of lasers to process wrapping sheets.

### BACKGROUND

Sheets of various kinds are used to wrap a corresponding item such as a foodstuff. These sheets often comprise, at least in part, one or more plastic materials. These sheets sometimes comprise single-ply sheets and sometimes comprise multi-ply sheets. In some cases the sheet is conformally wrapped around the item. In other cases the sheet forms a container into which the item can be placed and which can then be sealed. In many cases the sheet has substantive information printed thereon (such as a product name, instructions, nutritional information, manufacturer contact information, one or more barcodes, so-called sell-by dates, lot numbers or the like, serial numbers, contest numbers and information, and so forth).

Lasers are sometimes used to cut wrapping sheets in order to singulate an item wrapper from the sheet. Lasers have also been used to create perforations through a completed wrapper in order to facilitate the opening of the sealed wrapper by an end user or consumer. There are also suggestions in the art regarding use of a laser to form an image on a completed wrapper.

Though useful in some application settings, these prior art suggestions are not fully adequate to meet all demands. In some cases, for example, the application of such a processing step to a completed wrapper is impractical or cost prohibitive. In other cases the application setting presents challenges that urge the skilled practitioner away from laser usage.

### BRIEF DESCRIPTION OF THE DRAWINGS

The above needs are at least partially met through provision of the method and apparatus for using a laser to both score and emblazon a wrapping sheet described in the following detailed description, particularly when studied in conjunction with the drawings, wherein:

FIG. 1 comprises a flow diagram as configured in accordance with various embodiments of the invention;

FIG. 2 comprises a top plan detail view as configured in accordance with various embodiments of the invention;

FIG. 3 comprises a top plan view as configured in accordance with various embodiments of the invention;

FIG. 4 comprises a top plan view as configured in accordance with various embodiments of the invention;

FIG. 5 comprises a flow diagram as configured in accordance with various embodiments of the invention;

FIG. 6 comprises a side-elevational view as configured in accordance with various embodiments of the invention;

FIG. 7 comprises a top plan detail view as configured in accordance with various embodiments of the invention;

FIG. 8 comprises a top plan detail view as configured in accordance with various embodiments of the invention;

FIG. 9 comprises a side-elevational detail view as configured in accordance with various embodiments of the invention; and

FIG. 10 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a laser both scores and emblazons a sheet to thereby provide a scored, emblazoned sheet. That scored, emblazoned sheet is then used to wrap an item (such as, but not limited to, a foodstuff item). By one approach this can comprise providing a plurality of lasers and exposing a substantially taut sheet to this plurality of lasers. So configured, these lasers are used substantially contemporaneously with one another such that each laser both scores and emblazons a corresponding portion of the substantially taut sheet to provide the aforementioned scored, emblazoned sheet.

In some application settings the sheet comprises a plurality of laterally adjacent item lanes to facilitate forming corresponding individual item wrappers. By one approach, this can comprise having the laser form a score line across a plurality of such item lanes. When using a plurality of lasers, the portion serviced by each respective laser can itself include a plurality of such item lanes.

In some application settings the sheet will comprise a multi-ply sheet. By one approach, emblazoning the sheet can comprise removing one or more plies to reveal a ply of choice. This revealed ply can have a color or other visual characteristic that contrasts in some manner with the prevailing visual background in order to render the emblazoned emblem discernable to a viewer.

These teachings permit any of a variety of score lines to be formed in, and one or more emblems to emblazoned upon, a wrapping sheet prior to actually using that sheet to wrap an item. Those skilled in the art will appreciate that these teachings are readily applied in use with a wide sheet that serves to laterally include a plurality of item lanes that will eventually become individual, discrete item wrappers. These teachings are highly scalable and can be used with any number of lasers, sheets of varying materials and widths, and any of a wide variety of scoring or emblazoning requirements.

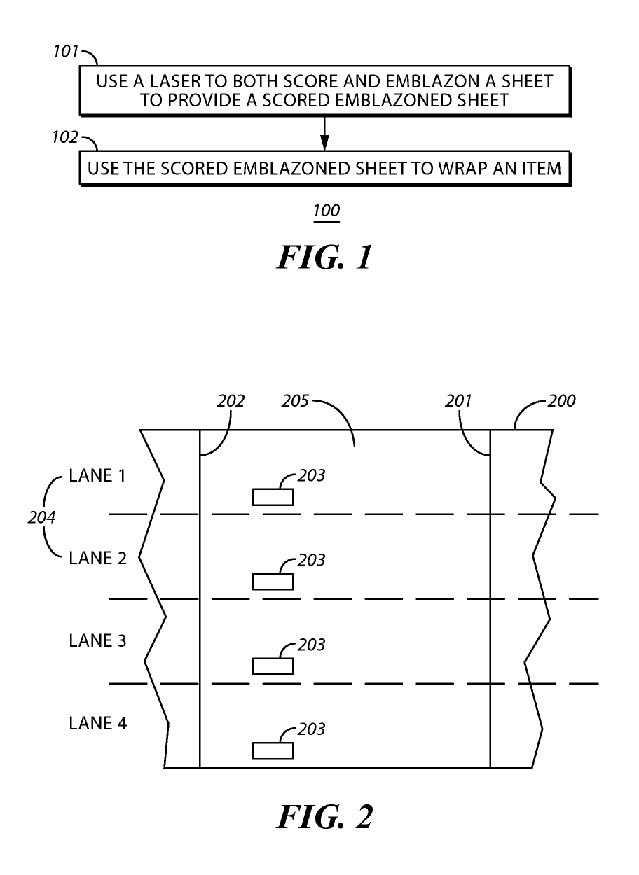

These and other benefits may become clearer upon making a thorough review and study of the following detailed description. Referring now to the drawings, and in particular to FIG. 1, an illustrative process 100 that is compatible with many of these teachings will now be presented.

This process 100 includes the step 101 of using a laser to both score and emblazon a sheet to provide a scored, emblazoned sheet. As used herein the expression “score” will be understood to refer to the making of a narrow, shallow indentation or notch in a given material for the purpose of providing a line along which the material can more easily be purposefully torn; the expression “score” does not refer to forming an opening that extends fully through the material such as a perforation. A score line serves here, ultimately, to make it easier for a person to open a wrapper formed of the sheet by tearing along the corresponding score line.

This score line will have a width that typically equals the width of the laser beam (such as 0.1 mm to 0.3 mm) with greater widths being possible by scribing adjacent, parallel lines with the laser. The depth of the score line can vary with the application setting and the material. When scribing a PET layer, for example, a depth of about 40 to 50% produces a score line that will permit opening by tearing, albeit with more resistance than may be suitable for some consumer applications. A depth of about 60 to 75% using such material produces a score line that permits easy opening by the average consumer.

By one approach this score line can be contiguous and consistent. For example, a continuous score line can have a consistent width and depth along its entire length. These teachings will accommodate other approaches, however. For example, the score line need not be continuous. Good results are obtained, for example, when forming a score line comprised of a series of short scores of about 2 mm in length separated by unscored 0.5 mm intervals. It would also be possible, if desired, to for a series of short scores having a first depth that are joined by intervening short scores having a second depth that is different from the first depth (such as being shallower or deeper).

As used herein, the expression “emblazon” will be understood to refer to inscribing an emblem into the material where the emblem comprises some visual device such as an alphanumeric representation (such as one or more words, numbers, dates, times, contest codes, product codes, serial numbers, lot numbers, or the like) or a graphic image such as a logo, an optical code (such as a barcode), or an icon. The emblem can comprise information that is statically applied (that is, information that remains unchanged from wrapper to wrapper over some period of time) or, if desired, can be dynamically applied. For example, a temporal indication (such as a “best when used by” date) can automatically index in synchronicity with a clock of choice (such as, for example, a clock made available with the laser platform employed for these purposes).

By one approach this emblem comprises substantive content; that is, content that conveys a representative meaning to the viewer. Text, for example, conveys a specific meaning that is represented by that text. As another example, a barcode typically conveys in a representative fashion information about one or more numbers or codes. As yet another example, a trademark logo conveys information to the viewer regarding the quality and/or source of the product. By way of comparison, a score line does not typically serve in these regards and instead comprises a physically-functional mechanism instead.

By one approach, the sheet can comprise a laminate formed of a plurality of plies. In this case, emblazoning the sheet can comprise using the laser to expose an inner layer of the laminate. This revealed layer can have a color (such as white) or other visual characteristic that contrasts in some manner with the prevailing visual background (such as a non-white background color) in order to render the emblazoned emblem discernable to a viewer.

Those skilled in the art will appreciate that these teachings will accommodate using the laser to score and emblazon the sheet using any preselected orientation. For example, by one approach, a score line can be formed in the sheet that traverses the width of the sheet. By another approach a diagonal line or a line that runs parallel to the length of the sheet can be accommodated. Similarly, the one or more emblems emblazoned on the sheet can have any X-Y orientation of choice.

This process 100 then provides the step 102 of using this scored, emblazoned sheet to wrap an item of interest. This item can vary with the needs of a given application setting. Examples include goods of all size, shape, and variety including foodstuffs, perishables, and non-perishable items.

These teachings can be employed when forming a single wrapper of the aforementioned sheet. These teachings can also be employed when forming a plurality of wrappers from such a sheet. For example, this process 100 can be utilized with a sheet of thin, flexible plastic material that is unspooled from a roll of such material. The use of rolls of flexible, plastic sheeting to form wrappers is known in the art. In some cases the width of the sheet exceeds the necessary dimensions of an individual wrapper. In such a case, in part to avoid waste, a number of protowrappers are often formed across the width of the sheet.

Referring now to FIG. 2, and as a non-limiting illustrative example in these regards, the width of a given sheet 200 is often subdivided into so-called lanes 204. In this illustrative example there are four such wrappable-item lanes 204. Those skilled in the art will recognize that there can be any number of lanes 204. The precise number of lanes 204 employed in a given application setting will depend upon the relative dimensions of the sheet 200 with respect to the individual protowrappers 205.

In this particular example, two score lines 201 and 202 are shown inscribed laterally across the entire width of the sheet 200. So configured, each score line 201 and 202 traverses a plurality of item lanes 204. In this example the score lines 201 and 202 are straight and are disposed perpendicular to the length of the sheet 200. Those skilled in the art will recognize that other possibilities exist in these regards as well. It should be noted that these score lines 201 and 202 are not the lines along which the sheet 200 will be severed in order to singulate the individual protowrappers 205 from one another.

This illustrative example also offers a schematic representation of an emblem 203 having been emblazoned on the sheet 200 using these teachings. In this example, one such emblem 203 has been emblazoned for each of the protowrappers 205. Here, the emblem 203 comprises a relatively small proportion of the protowrapper 205. Those skilled in the art will recognize that the size, shape, and placement of this emblem 203 can vary with the needs and/or limitations as tend to characterize a given application setting. It will also be understood that these teachings will readily accommodate emblazing two or more discrete emblems 203 for each such protowrapper 205. It will also be understood that these emblems 203 can vary from one another such that different protowrappers 205 on the same sheet sport differing emblems 203.

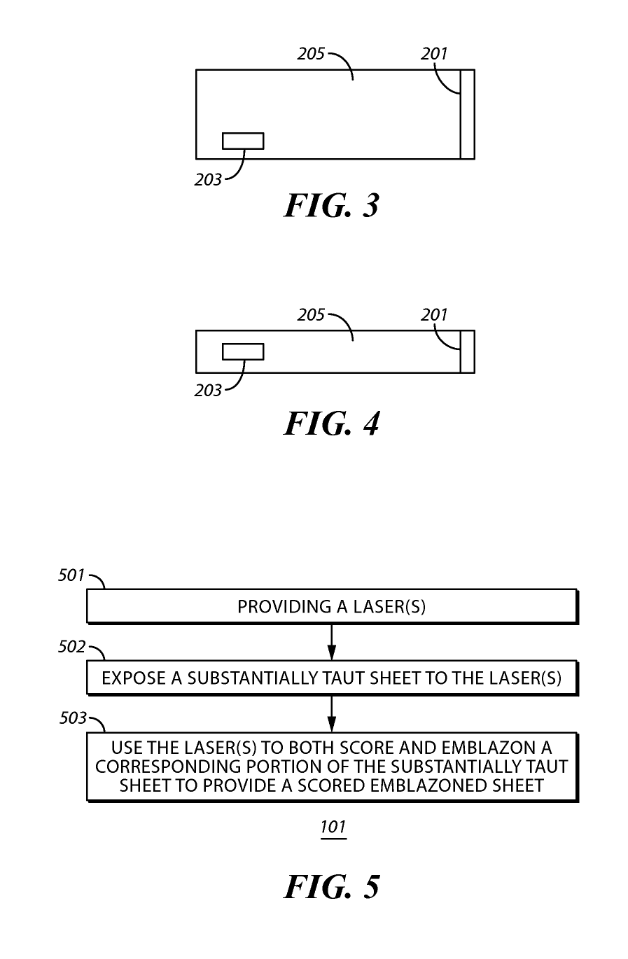

Following the aforementioned step 101 of scoring and emblazing the sheet 200 the protowrappers 205 can be singulated to separate them from one another as shown in FIG. 3. This view makes it easier to appreciate that, in this illustrative embodiment, each individual wrapper 205 has only a single score line 201 formed there across.

Referring now to FIG. 4, this wrapper 205 can be folded about its longitudinal axis and the various open edges sealed using any of a variety of known sealing methodologies. As these teachings are not overly sensitive to any particular selection in this regard, for the sake of brevity and the preservation of clarity, further elaboration in this regard will not be presented here. So configured, however, it can be seen that the emblem 203 remains visible and its substantive content readily available to the viewer. It can also be seen that the score line 201 extends fully around the periphery of the wrapper 205 at one end thereof and offers a simple and reliable way for the consumer to easily tear open the wrapper 205 to access the item contained within the wrapper 205.

Those skilled in the art will appreciate the numerous benefits that attend the employment of these teachings. For example, these teachings readily accommodate wide sheets. Wide sheets, in turn, are often easier to handle than small singulated individual wrappers. These teachings also permit a single laser to provide desired scoring and emblazoning services with a plurality of wrappers in a single processing step. This, in turn, can lead to reduced costs.

Referring now to FIG. 5, further details regarding the aforementioned step 101 of using a laser to both score and emblazon a sheet will now be provided. Those skilled in the art will recognize and understand that these details are intended to serve only in an illustrative capacity and are not intended to comprise an exhaustive listing of all possibilities in these regards.

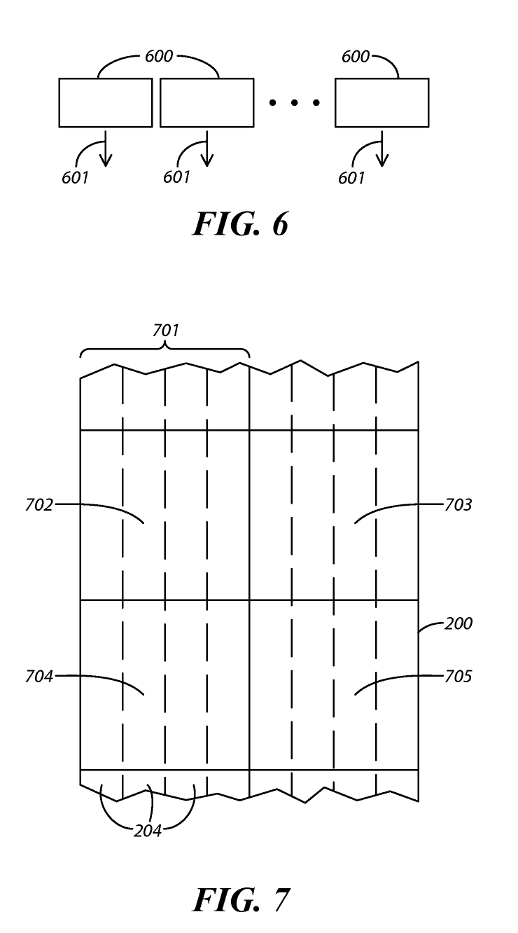

This particular approach includes the step 501 of providing one or more lasers. By one approach, this can comprise providing SUNX brand laser-marking stations as offered by Panasonic. In some cases, where the laser is particularly capable and/or where the sheet is relatively narrow in width, a single laser may suffice. In many cases, however, a plurality of lasers will be useful or necessary. In such a case, many or all of these lasers will each perform the aforementioned scoring and emblazoning. With momentary reference to FIG. 6, in some cases the use of plural lasers 600 may be accommodated by arranging the lasers 600 in a line across the width of the sheet (not shown).

So configured, the laser beam 601 from each laser 600 can process (by scoring and emblazoning) a corresponding portion of the work surface. For example, and referring now to FIG. 7, two adjacent lasers (not shown) can each process a discrete portion of the sheet 200. In this simple illustrative example, the sheet 200 accommodates eight item lanes 204. The first laser processes a first portion 702 while the second laser processes a second portion 703 that is laterally adjacent to the first portion 702. Each laser can then process a subsequent following portion 704 and 705, respectively, as the sheet 200 and lasers move relative to one another. (Generally speaking, the lasers will have little or no mobility; instead the sheet will be moved (either continuously or in an indexed stop-and-go manner).)

It will be understood that additional lasers can be added to accommodate a wider sheet. It will also be understood that the number of item lanes 204 processed by each laser can vary as well with respect to the application setting.

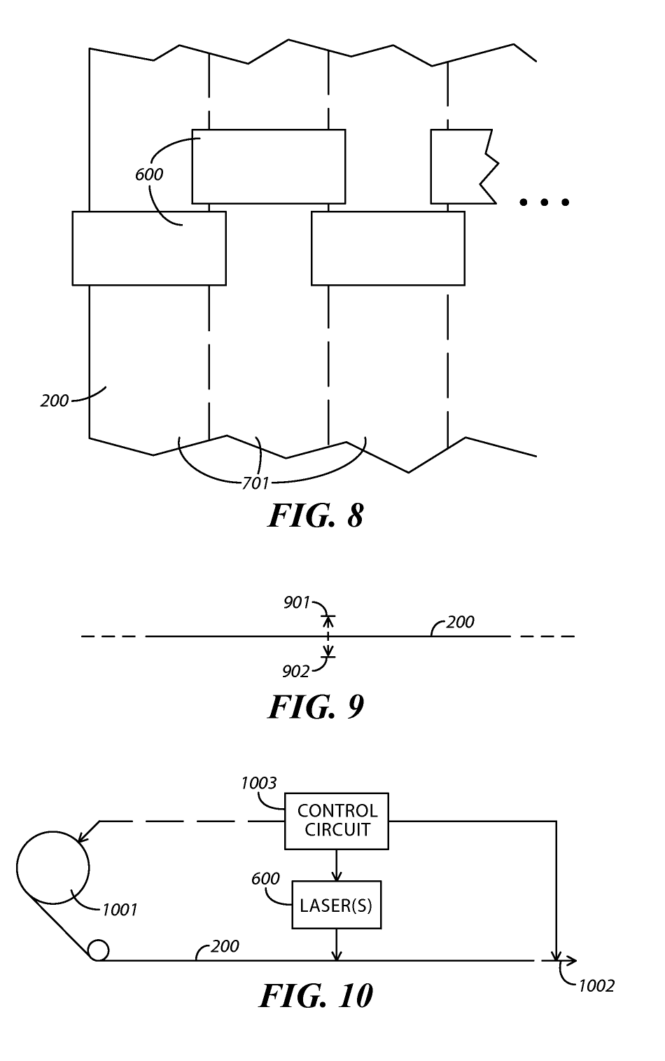

In some cases, it may not be possible to position a plurality of lasers directly and serially adjacent to one another. Problems can arise, for example, when the laser's form factor width is greater than its processing width. In such a case, placing multiple lasers directly adjacent one another in a linear fashion will leave processing gaps where no laser beam can reach. In such a case, and referring now to FIG. 8, the plurality of lasers 600 can be offset from one another. In this illustration the processing width for each laser 600 is denoted by reference numeral 701 and it can be seen that the form factor width of each laser 600 exceeds this processing width 701. By offsetting the lasers 600 from one another as shown, however, no part of the sheet 200 is unreachable by a laser beam. These teachings will accommodate a variety of offsetting schemes. In this particular example, two rows of offset lasers 600 achieve the desired processing coverage.

Referring again to FIG. 5, this approach also provides the step 502 of exposing a substantially taut sheet to the one or more provided lasers. By one approach, the sheet is placed under sufficient tension to serve to retain the sheet in a substantially taut planar state. As used herein, this expression “substantially taut planar state” will be understood to refer to states ranging from being absolutely planar to being slightly offset. Referring momentarily to FIG. 9, and to be more specific, an offset of up to plus or minus 1.5 mm (as denoted by reference numerals 901 and 902) is included within the expression “substantially taut planar state.” This tautness prevails in both the X and Y directions.

Referring again to FIG. 5, step 503 provides for using the lasers to each score and emblazon a corresponding portion of the substantially taut sheet to thereby provide the aforementioned scored and emblazoned sheet. When using a plurality of lasers, this step 503 can comprise using the plurality of lasers substantially contemporaneously with one another. In other words, at least part of the time, these lasers are all scoring or emblazoning the sheet at the same time. By one approach, these lasers can all be “on” and “off” at the same time. By another approach, there can be temporal differences with respect to when individual lasers switch “on” or “off” but their “on” times overlap with one another to at least some extent.

As noted earlier, when the sheet is subdivided in a working sense into a plurality of item lanes, these teachings will accommodate forming a score line fully (or less than fully if so desired) laterally across the width of the sheet. When using a plurality of lasers that each process a corresponding portion of the sheet, this score line can be formed in one of the portions by the laser that corresponds to that portion while another section of the score line is formed in another one of the portions by the laser that corresponds to that another portion. Using this approach, a single contiguous score line can be formed using a plurality of lasers.

Differing laser energy densities can be applied when scoring and emblazoning the sheet. These teachings will support using this approach when applying one laser or multiple lasers. For example, each of a plurality of lasers can use a first energy density when scoring the substantially taut sheet and a second energy density (that is greater than the first energy density) when emblazoning the substantially taut sheet. This will permit, for example, cutting further into the sheet when emblazoning the sheet than when scoring the sheet.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 10, an illustrative approach to such a platform will now be provided.

In this illustrative example, a spool 1001 contains a sheet 200 of considerable length (for example, hundreds or thousands of meters). A sheet conveyor 1002, in turn, conveys the sheet 200 past one or more lasers 600. Here, in this illustrative example, the sheet conveyor 1002 (alone or in cooperation with one or more other components (not shown) maintains the sheet in a substantially taut and planar state. Depending upon the configuration of this overall platform, the sheet conveyor 1002 may move the sheet 200 at a relatively constant speed or may move the sheet 200 in a stop-and-go indexed manner. It would not be unusual, for example, to using an indexing approach when the sheet 200 feeds a filling process that itself observes, for example, a 40 stroke-per-minute production schedule.

A control circuit 1003 operably couples to the laser(s) 600 and, in this illustrative example, to the sheet conveyor 1002 as well. Those skilled in the art will recognize that the control circuit 1003 may only communicate directly with the laser(s) 600 in a system where the operations of the sheet conveyor 1002 are otherwise sufficiently consistent and predictable. Those skilled in the art will recognize and appreciate that such a control circuit can comprise a fixed-purpose hard-wired platform or can comprise a partially or wholly programmable platform. All of these architectural options are well known and understood in the art and require no further description here.

So configured, the control circuit 1003 can be configured (using, for example, corresponding programming as will be well understood by those skilled in the art) to carry out one or more of the steps, actions, or functions described herein. This can comprise, for example, configuring the control circuit 1003 to cause the laser(s) 600 to both score and emblazon the sheet 200 being conveyed by the sheet conveyor 1002 prior to that sheet being used to wrap an item.

So configured, both scoring and emblazoning a wrapper occurs prior to wrapping a given item. The use of a same laser to both score and emblazon the wrapper, at least in part, ensures an efficient and economical approach well suited to numerous application settings. The ability of these teachings to readily accommodate any number of lasers, sheets of any relative dimensions, and any number of wrappable-item lanes represents a useful degree of scalability. It will further be appreciated that these teachings are readily employed in conjunction with numerous existing platforms, techniques, and methodologies and hence are highly leveragable as well.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in these regards, these teachings will readily accommodate effecting the scoring and emblazoning in any desired order. This can comprise first scoring the sheet and then emblazoning the sheet using a given laser. Or, this can comprise first emblazoning and then scoring the sheet using a given laser. This can also comprise first partially scoring the sheet, then emblazoning the sheet, and then concluding the scoring of the sheet. Numerous other permutations and combinations in these regards are similarly possible.

We claim:

1. A method comprising:
using a laser to both score and emblazon a sheet to provide a scored emblazoned sheet;
using the scored emblazoned sheet to wrap an item.

2. The method of claim 1 wherein using the laser to score the sheet comprises using the laser to provide a score across a plurality of item lanes.

3. The method of claim 1 wherein using a laser to both score and emblazon a sheet comprises using a laser to both score and emblazon a sheet that is under sufficient tension to serve to retain the sheet in a substantially taut planar state.

4. The method of claim 1 wherein using the laser to both score and emblazon a sheet comprises using a first energy density when laser scoring the sheet and a second energy density when emblazoning the sheet, wherein the second energy density is greater than the first energy density.

5. The method of claim 1 wherein the sheet comprises a laminate and wherein using the laser to emblazon the sheet comprises using the laser to expose an inner layer of the laminate.

6. The method of claim 1 wherein using a laser to both score and emblazon a sheet comprises using a plurality of lasers, wherein each laser serves to both score and emblazon the sheet.

7. The method of claim 6 wherein using a plurality of lasers comprises using the plurality of lasers substantially contemporaneously.

8. The method of claim 1 wherein using a laser to emblazon a sheet comprises using the laser to emblazon discrete protowrappers with differing substantive content.

9. The method of claim 1 wherein using the laser to score and emblazon the sheet comprises using the laser to score and emblazon the sheet using any preselected orientation.

10. A method for use in preparing a sheet to be used as individual wrappers for a plurality of individual items, comprising:
providing a plurality of lasers;
exposing a substantially taut sheet to the plurality of lasers;
substantially contemporaneously with one another, using each of the lasers to both score and emblazon a corresponding portion of the substantially taut sheet to provide a scored emblazoned sheet;
using the scored emblazoned sheet for wrapping purposes.

11. The method of claim 10 wherein the portion comprises a plurality of wrappable-item lanes.

12. The method of claim 11 wherein using each of the lasers to score the sheet comprises using the plurality of lasers to form a single contiguous score line across the substantially taut sheet.

13. The method of claim 11 wherein using each of the lasers to emblazon the substantially taut sheet comprises using the plurality of lasers to individually emblazon each of the plurality of wrappable-item lanes as comprise the substantially taut sheet.

14. The method of claim 10 wherein using each of the lasers to both score and emblazon a corresponding portion of the substantially taut sheet comprises using a first energy density when scoring the substantially taut sheet and a second energy density when emblazoning the substantially taut sheet, wherein the first energy density is less than the second energy density.

15. An apparatus comprising:
a sheet conveyor;
at least one laser;
a control circuit operably coupled to the at least one laser, wherein the control circuit is configured to cause the laser to both score and emblazon a sheet being conveyed by the sheet conveyor prior to using the sheet to wrap an item.

16. The apparatus of claim 15 wherein the sheet conveyor maintains the sheet in a substantially taut planar state while the laser scores and emblazons the sheet.

17. The apparatus of claim 15 wherein the control circuit is configured to cause the laser to fully laterally score the sheet.

18. The apparatus of claim 15 wherein the at least one laser comprises a plurality of lasers and the control circuit is configured to cause the plurality of lasers to each both score and emblazon the sheet prior to using the sheet to wrap an item.
